(19) United States
(12) Patent Application Publication
(10) Pub. No.: US 2016/0229879 A1
(43) Pub. Date: Aug. 11, 2016

(54) Lignin Derivatives

(71) Applicants: Dhrubojyoti Dey Laskar, Erie, CO (US); John Allen Yegge, Longmont, CO (US); Andrew Stephen Boswell, Madison, WI (US); Sara Jordan Chmelka, Westminster, CO (US); Leslie W. Joy, Denver, CO (US); Ryan Carl Allen Tarrant, Worcester, MA (US); David Cole DeCoster, Lyons, CO (US); Richard C. Wingerson, Sandpoint, ID (US); Edwin R. Lehrburger, Denver, CO (US)

(72) Inventors: Dhrubojyoti Dey Laskar, Erie, CO (US); John Allen Yegge, Longmont, CO (US); Andrew Stephen Boswell, Madison, WI (US); Sara Jordan Chmelka, Westminster, CO (US); Leslie W. Joy, Denver, CO (US); Ryan Carl Allen Tarrant, Worcester, MA (US); David Cole DeCoster, Lyons, CO (US); Richard C. Wingerson, Sandpoint, ID (US); Edwin R. Lehrburger, Denver, CO (US)

(73) Assignee: PUREVISION TECHNOLOGY, LLC, Fort Lupton, CO (US)

(21) Appl. No.: 14/618,976

(22) Filed: Feb. 10, 2015

(51) Int. Cl. C07G 1/00

(52) U.S. Cl. CPC C07G 1/00

(57) ABSTRACT

The present invention provides lignin derivatives having a certain physical and/or chemical properties. In particular, the lignin derivatives of the invention have particular NMR spectral characteristics, impurity content, average molecular weight, and/or other characteristics.

### FIELD OF THE INVENTION

The present invention relates to lignin derivatives having a certain physical and/or chemical properties. In particular, the lignin derivatives of the invention have particular NMR spectral characteristics, impurity content, average molecular weight, and/or other characteristics. Surprisingly and unexpectedly, the lignin derivatives of the invention are found to undergo facile degradation reaction and other chemical transformation, thereby rendering them suitable for producing a wide variety of chemicals that can be used as starting materials for producing other aromatic compounds.

### BACKGROUND OF THE INVENTION

Lignin is a natural amorphous polymer that acts as the essential glue that gives plants their structural integrity. It is one of the main constituents of lignocellulosic biomass (15-30% by weight, 40% by energy), together with cellulose and hemicelluloses, and the most abundant source of aromatic compounds outside of crude oil [1, 2]. Lignin unlike most natural polymers which consist of a single intermonomeric linkage, have no structural regularity within its polymeric framework and comprised of various carbon-to-carbon and ether linkages [3-9]. Without being bound by any theory, it is believed that the network of the lignin polymer primarily includes p-hydroxyphenyl (H), guaiacyl (G), and syringyl (S) units, derived from the dehydrogenation and polymerization of three different hydroxycinnamyl alcohols (monolignols), namely p-coumaryl alcohol, coniferyl alcohol, and sinapyl alcohol, respectively [10-12]. It has been shown that in general softwood lignin is composed mainly of coniferyl alcohol units, while hardwood lignin is composed of coniferyl and sinapyl alcohol units. Lignin from grasses contains guaiacyl, syringyl and p-hydroxyphenyl (H) structure units. Typically, the abundance of lignin in lignocellulosic biomass varies depending on the biomass. For example, in general the amount of lignin present in softwood ranges from 27˜33%, in hardwood the amount of lignin ranges typically from 18˜25%, and in grass the amount of lignin ranges typically from 17˜24%.

Although the exact structure of protolignin is unknown, improvements in methods for identifying lignin degradation products and advancements in spectroscopic methods have enabled one skilled in the art to elucidate the predominant structural features of lignin. The structure of lignin and its chemistry has been extensively studied by Ralph and co-workers and these advances have dramatically enhanced understanding of this biopolymer [3-6, 11].

The polymeric framework of lignin, in which monolignols are usually linked together via radical coupling reactions [12, 13] at its C8, C7 and C4 positions, results in formation of various inter-unit linkages and/or substructures [11]. Among all the substructures, 8-O-4′ (aryl ether) inter-unit linkage is believed to be the most predominant and readily cleavable either chemically or biochemically, providing a basis for deconstruction of polymeric framework in various industrial processes and several analytical methods. By comparison, the other linkages, such as 8-5, 8-8, 5-5, 5-O-4′, and 8-1, are more resistant to chemical/biological degradation. It is noteworthy to mention that the relative abundance of the different inter-linkages largely depends on the relative contribution of a particular monomer during the lignin polymerization process. For example, softwood lignin mainly composed of G-units, contains more resistant (8-5, 5-5, and 5-O-4′) inter-unit linkages than hardwood lignin incorporating S units, due to readily available C5 sites for coupling.

Isolation of native lignin from plant cell-wall in an unaltered form is mainly hindered by the tight physical binding and chemical linkages between cell-wall polysaccharides. In fact, efficient recovery of lignin turns out to be more challenging than the plant cell wall structural carbohydrates due to the enormous complexity in its polymeric framework. Traditionally milled wood lignin (MWL) has been used as a representative source of native lignin [14]. The procedure for isolating milled wood lignin involves the production of wood meal by Wiley milling of the wood, followed by vibratory or rotary ball milling, and subsequent extraction with dioxane-water. The yield of MWL varies depending on the extent of milling, ranging from 25% to 50% [15]. However, severe chemical modification of the lignin occurs. In fact, increases in carbonyl content and phenolic hydroxyl content, as well as decreases in molecular weight and cleavage of aryl ether linkages, have been reported as a result of the MWL isolation procedure [16, 17]. In addition, extraction of lignin with various solvents, such as phenol, thioglycolic acid and acetic acid, have been reported previously [18]. There were also other isolation procedures established using combination of solvent and co-solvent such dioxane/H₂O, and dimethylsulfoxide (DMSO) [18-20]. Several chemical processes that typically dissolve most of the lignin and also some of the carbohydrates using inorganic chemicals have been developed for pulping in papermaking [21, 22].

The intrinsic value of the lignin continues to be largely overlooked in comparison to its cellulosic counterpart, which has garnered substantial attention as a feedstock for ethanol biofuel and other basic chemicals. The underutilization of lignin is a result of the low reactivity of today's commercial lignins produced primarily from the pulp & paper industry, which diminishes many higher value applications. Commercially, lignin is obtained as a by-product of the paper industry, separated from wood by chemical pulping processes. These lignins have chemical characteristics that depend on the pulping process. In general, different chemical treatments during wood-pulping processes yield diverse types of lignins, such as Thermo-mechanical pulp lignin (TMPL), Alcell, and Kraft lignin. These processes employ either or both NaOH and Na₂S, producing soluble lignins at pulping temperatures that are typically between 165° C.-170° C. [23]. Generally, lignin fractions were recovered from spent black liquor by ultrafiltration and precipitation with acid or combination of both [24-31].

Recovery of high purity sulfite lignin with the use of ultrafiltration with polyacrylonitrile membranes from spent sulfate black liquor has been well described [27]. Various membranes, such as polysulfone, poly(ether-sulfone), and poly(vinylidene fluoride), of different molecular weight have been successfully employed for ultrafiltration in efficient recovery of lignin from black liquor [29]. Although ultrafiltration processes were successfully demonstrated for lignin recovery from black liquor, acid precipitation method provided superior separation at lower capital and operating costs compared to ultrafiltration techniques [24, 25, 28, 31]. Antonsson et. al. (2008) reported recovery of low molecular weight lignin fractions from black liquor from kraft pulping process using a cross-flow nano-filtration process [32]. Interestingly, such low molecular weight lignin fraction exhibited different characteristics from the commonly produced kraft lignin and represented new material source for novel applications [32]. However, by comparison to other lignins, such purified lignin does not restrain the lignin primary structure despite of the existence of diverse substructures and/or inter-unit linkages, such as 8-O-4′, 8-5, 8-8, etc.

It is believed that a large-scale production of biofuel ethanol from carbohydrates in biomass will also result in a process stream rich in lignin. Although a certain amount of lignin (˜30-50%) can be used for the steam and electricity requirements to power cellulosic ethanol production, a modern cellulosic processing plant will have an excess of lignin that could be utilized as a feedstock for biodiesel, drop-in replacement fuels, and/or green chemicals. In the last few years, there has been immense interest towards improving biorefinery processes for utilizing biomass derived lignin to produce high-value products. The development of such process instigates from the necessity of finding a substitute to the petroleum-based industry to produce both products and energy [33]. New technologies are sought to create and provide avenues for separation of lignin from cellulose and/or hemicellulose undergoing chemical or biological conversion to chemicals and fuels [34-38]. The challenge, however, is propensity of lignin macromolecular assembly to competently depolymerize and degrade into smaller fragments, thereby generating very high amounts of solid residue in the biorefinery process as compared to its cellulosic counterpart [39, 40].

Therefore, recovery of lignin under these operations and its subsequent conversion to value added products is desirable to enhance the profitability of biorefinery [33]. Lignin's aromatic nature and its versatile functional groups suggest that it can be a valuable source of chemicals, particularly monomeric phenolic compounds. Depending on the chemical structure, the recovered lignin can serve as an abundant renewable resource for production of value added products instead of the waste disposal problem it poses today. Thus, the production of value-added lignin form offers a significant opportunity for enhancing the overall operational efficiency, carbon conversion rate, and economic viability of an integrated biorefinery process aimed at complete utilization of biomass for economical operation and multiproduct development.

### SUMMARY OF THE INVENTION

Some aspects of the invention relate to lignin derivatives having unique physical and/or chemical properties. In one particular embodiment, the lignin derivatives of the invention have better chemical reactivity, physical properties, or a combination thereof. Thus, the lignin derivatives of the invention can be more easily converted to other useful chemical products than other conventional lignin derivatives.

One specific aspect of the invention provides a lignin derivative recovered from a biorefinery process of a lignocellulosic biomass, wherein said lignin derivative has no ethoxy substituent in the 2D HSQC NMR spectra, and ash content of about 1.5% or less. In some embodiments, the lignin derivatives of the invention comprise sugar content of about 10% or less. Yet in other embodiments, lignin derivatives of the invention comprise Klason Lignin (KL) content of about 95% or less. Through various chemical analysis and characterization, the present inventors have also discovered that some lignin derivatives of the invention comprise p-coumaric acid. In still other embodiments, the lignin derivatives of the invention comprise etherified G-units. Yet in other embodiments, the lignin derivatives of the invention comprise etherified S-units. In other embodiments, the lignin derivatives of the invention comprise methoxy groups. Still yet in other embodiments, the lignin derivatives of the invention comprise lower 8-5′ (phenylcoumaran) and 8-8′ (resinol) lignin inter-unit linkages. In further embodiments, the lignin derivatives of the invention comprise higher degree of 8-O-4′ (aryl ether) inter-unit linkages. Yet in other embodiments, the number-average molecular Weight (Mₙ) of the lignin derivatives of the invention range from about 200 g/mol to about 2000 g/mol. In other embodiments, the weight-average molecular Weight (M_{W}) of the lignin derivatives of the invention range from about 500 g/mol to about 4000 g/mol.

It should be appreciated that throughout this disclosure, the scope of the invention includes combination of various embodiments of the lignin derivatives. For example, some lignin derivatives have no ethoxy substituent in the 2D HSQC NMR spectra, ash content of about 1.5% or less; sugar content of about 10% or less; and Klason Lignin (KL) content of about 95% or less. In this manner, a wide variety of combination of physical and/or chemical property of lignin derivatives in encompassed in the scope of the invention.

Still another aspect of the invention provides a lignin derivative having ¹H NMR peaks at: δH ˜4.0 ppm to 5.5 ppm, δH ˜6.4 ppm to 6.6 ppm, δH ˜6.8 ppm to 7.2 ppm, δH ˜7.3 ppm to 7.5 ppm, and δH ˜9.0 ppm to 10.0 ppm. In some embodiments, the lignin derivative also has ¹³C NMR peaks at: δc ˜60 ppm to 90 ppm, δc ˜102 ppm to 107 ppm, δc ˜107 ppm to 124 ppm, δc ˜145 ppm to 154 ppm, δc ˜150 ppm to 154 ppm, and δc ˜165 ppm to 169 ppm.

Yet in another aspect, the lignin derivatives of the invention comprise inverse gated ¹³C NMR peak at δc ˜55.8 ppm. In one particular embodiment, the lignin derivatives of the invention further comprise 2D HSQC NMR peak at δc/δH ˜55.8/3.7 ppm. Yet in another embodiment, the lignin derivatives of the invention have no peaks at δc/δH ˜15.5/1.1 ppm in the 2D HSQC NMR spectra. Still in another embodiment, the lignin derivatives of the invention have no peaks at δc/δH ˜63.5/3.3 ppm in the 2D HSQC NMR spectra.

### BRIEF DESCRIPTION OF THE DRAWINGS

FIG. 1 is ¹H NMR spectrum of sugarcane bagasse lignin derivatives with the inset displaying the expanded aromatic region.

FIG. 2 is ¹H NMR spectrum of corn stover lignin derivatives with the inset displaying the expanded aromatic region.

FIG. 3 is ¹³C NMR spectra of sugarcane bagasse lignin derivatives (arrows indicates the corresponding chemical shift resonance of H, G, and S lignin sub-units).

FIG. 4 is ¹³C NMR spectra of corn stover lignin derivatives (arrows indicates the corresponding chemical shift resonance of H, G, and S lignin sub-units).

FIG. 5 is the gradient selected 2D HSQC NMR carbon-proton correlations of alkoxy region for sugarcane bagasse lignin derivatives (arrows indicates the corresponding C—H cross peaks of ethoxyl and methoxyl groups).

FIG. 6 is the gradient selected 2D HSQC NMR carbon-proton correlations of alkoxy region for corn stover lignin derivatives (arrows indicates the corresponding C—H cross peaks of ethoxyl and methoxyl groups).

### DETAILED DESCRIPTION OF THE INVENTION

The present invention provides a lignin derivative obtained from a biorefinery process of a lignocellulosic biomass. A promising lignin recovery approach from the hydrolysate streams of PVT's Continuous Countercurrent Reactor (CCR) and the Dilute Acid, Solvent-assisted Hydrolysis (DASH) process has been developed, with the resulting lignin containing native inter-unit linkages/functional groups and low molecular weight than its native form. The CCR-DASH rapid hydrolysis technology entails a lignin dissolving process using high percentage of organic solvent (e.g. 70%-90% acetone) in the counter flow liquid. Accordingly, lignin is hydrolyzed by treating the biomass in an organic or aqueous-organic solvent mixture with the addition of an inorganic acid catalyst, such as H₂SO₄ (U.S. Pat. Nos. 6,419,788, 6,620,292, 7,600,707, 7,717,364 and 8,136,747). The bulk of biomass lignin is solubilized and dissolved in the counter flow liquid during the CCR-DASH process along with most of the hemicellulose sugars. Native lignin derivatives can be recovered from the discharged DASH hydrolysates after solvent evaporation and/or followed by precipitation methods. By sequentially diluting the DASH hydrolysates with water (or acidic water) to change the water and solvent ratio, lignin fractions with different molecular weight distributions can be readily obtained due to their different solubility in solvent/water mixtures. The CCR-DASH process can thus yield a relatively pure, low molecular weight and less altered/condensed lignin. The CCR-DASH is of interest because it produces lignin with desirable characteristics for generation of several co-products, and importantly differing in their alkoxy groups and lignin side chains in comparison to other organosolvent lignin as described in U.S. Pat. No. 8,426,502, patent application Ser. Nos. 12/705,939, 12/705,938 and 13/826,817.

PVT has developed an advanced rapid hydrolysis technology that combines two major innovations: the Continuous Countercurrent Reactor (CCR) and the Dilute Acid, Solvent-assisted Hydrolysis (DASH) process chemistry, to convert diverse lignocellulosic biomass into fully hydrolyzed monosaccharides and native lignin derivatives suitable for downstream conversion to higher-value product streams. Unlike current biobased products produced from food biomass such as corn glucose or cane sucrose used to produce biofuels, bio-plastics and bio-based chemicals, PVT's CCR-DASH technology uses non-food feedstocks including agricultural residues and energy crops. Utilization of such lignocellulosic feedstocks reduces and potentially replaces the demand for food biomass as source materials for non-food applications. The PVT technology is designed to meet the market needs for non-food bio-based products. PVT's CCR processing of biomass allows the highly recalcitrant counterpart of biomass solids to progressively encounter more aggressive reaction conditions in the reactor, while the less recalcitrant biomass components encounter milder reaction conditions. This allows the total moving fluid to become increasingly more concentrated in sugars with solubilization and separation of native lignin isolates.

A description of the PVT's CCR-DASH process can be found in U.S. Pat. Nos. 6,419,788, 6,620,292, 7,600,707, 7,717,364 and 8,136,747. PVT also has patents pending and many trade secrets associated with its technology. The PVT countercurrent process offers more complete and effective reaction than other reactor designs. Acid consumption is lowered and undesired side reaction products are significantly reduced. PVT's DASH process using a continuous countercurrent reactor (CCR) has a number of advantages over existing biomass conversion approaches. The DASH technology: 1) is feedstock agnostic; 2) produces concentrated mixed sugars; 3) utilizes a solvent-rich reagent that is recycled; 4) produces native lignin with 80% to 90% purity: 5) can utilize chip-size biomass at commercial scale; 6) lowers severity, enhances hydrolysis rates, reduces sugar and lignin degradation while improving sugar purity.

It is important to note that the literature describes multiple methods for extraction of phenolic material from acidified black liquor via carbon dioxide addition, acidification, dewatering, and other methods [41-44]. Previous methods have used the addition of acidifying solvents or sulphur containing solution to facilitate the precipitation of lignin. The advantage of this process is minimal addition of acidifying solution. The cost saving by this minimal solvent and pH manipulation in the extraction of lignin and by-products can be significant at commercial scale. The separation of lignin within organosolv process hydrolysates can add significant value to biorefinery commercial production of cellulosic sugars. The separated lignin can be used as an additive for many industrial polymers, solvents, “green chemicals” and fertilizers depending upon the quality of lignin. Using lignin as a “green chemical” is more desirable due to increase value of lignin as chemical product [45-47]. The separation of lignin from polysaccharides is also crucial to optimize hydrolysis. The presence of lignin within a hydrolysate can also decrease the overall hydrolysate filterability. Lignin can also form chemical bonds with oligomeric and monomer carbohydrates to increase their recalcitrant to dilute acid hydrolysis. The separation of lignin before a secondary hydrolysis step will increase the overall hydrolysis yield and decrease downstream process fouling.

The present invention provides derivatives of native lignin recovered during and/or after CCR-DASH rapid hydrolysis of agricultural residues and energy crops. Examples of agricultural residues and energy crops include: sugarcane bagasse, corn stover, corn cobs, wheat straw, industrial hemp, etc., and combinations/hybrids thereof. According to the present invention, derivatives of native lignin recovered from CCR-DASH hydrolysates of agricultural residues and energy crops feedstock are found to have Klason Lignin (KL) content of about 95% or less, about 90% or less, about 85% or less, about 80% or less, about 75% or less.

In carrying out the invention, in one particular instant, the CCR is operated with a dry biomass feed rate of approximately 150-350 g/min and a liquid:solid ratio (wt/wt) between 3:1 and 8:1. Operating temperatures range from 160-210° C. and pressures from 600-900 psi. The hydrolysate slurry discharges from the CCR and pressure is reduced to atmospheric through a flash valve. An adiabatic flash tank removes approximately 50% of the solvent reagent from the hydrolysate. The hydrolysate then collected for downstream recovery of native lignin derivatives of 80% to 90% purity.

One particular aspects of the invention disclose method for recovery of native lignin derivatives where the CCR-DASH hydrolysates from the countercurrent reactor was spun in a centrifuge, 3800 rpm, for 10 minutes to sediment impurities and unhydrolyzed cellulose fines. The decantate, pH 1.7 to 2.8 was placed in a sealed Erlenmeyer flask attached to a short path distillation column to collect organic solvent. The decantate was heated to 60° C. to 70° C. for 5 minutes. The decantate was cooled to ambient temperature. Lignin was precipitated via addition of the decantate to water with vigorous mixing at a ratio of 5 to 1 water to decantate. The lignin precipitate was then filtered using a 40 um glass fiber filter and dried in vacuo at 30° C.

Other aspects of the invention provide purification of native lignin derivative from the CCR liquid hydrolysate stream by centrifugation to remove cellulosic fines, followed by heating the clarified liquid to 70° C. to reduce solvent (e.g., acetone) and precipitate the lignin as an amorphous tar like material. The sugar rich liquid was decanted and the solids were re-solubilized in 80 mL of 7:1 acetone/water mixture. The resulting solution was volume reduced to 50 mL by rotary evaporation, and the lignin was precipitated by slow addition of the concentrate into 1200 mL of water at near neutral pH (6.5 to 7.0). The resulting free flowing lignin solids were separated from the liquid by vacuum filtration and washed with water before drying in vacuo at 30° C.

In some embodiments, two different liquid hydrolysate fractions from the PVT's CCR-DASH process were combined to produce native lignin derivatives at pilot scale. The first liquid fraction was produced with acetone/water/sulfuric acid (w:w:w) ranging from 92:8:0.3 to 90:10:0.3 at temperature range from 180° C. to 200° C. with a liquid flow rate of 918 g/minute to 1400 g/minute and a dry biomass feed rate of 137 g/minute to 142 g/minute. The second fraction being produced in the countercurrent reactor at temperature ranging from 180° C. to 200° C. with acetone/water/sulfuric acid (w:w:w) from 82:18:0.5 to 92:8:0.3, at a liquid flow rate of 1390 g/minute to 1418 g/minute and a dry biomass feed rate of 125 g/minute to 135 g/minute. The combined hydrolysate liquids were then heated to 58° C. to reduce acetone and concentrate the lignin in the resulting liquor. To precipitate the lignin, the concentrated liquor was slowly added to 4 volumes of water acidified to pH 2.3 with sulfuric acid. The lignin precipitate was isolated by filtration, washed with 10:90 acetone/water solution followed by a second water wash and finally dried the recovered lignin precipitates at 35° C. at 1 bar pressure.

In some embodiments, the lignin derivatives of the invention, regardless of feedstock, were found to contain ash content of about 1.5% or less, typically 1% or less, and often 0.5% or less. Yet in other embodiments, the lignin derivatives of the invention, regardless of feedstock, were found to contain sugar content of about 10% or less, typically about 5% or less and often about 1% or less. Still in other embodiments, the lignin derivatives of the invention, regardless of feedstock, were found to contain Klason Lignin (KL) content of about 95% or less, typically about 90% or less, often about 85% or less, and more often about 80% or less.

The present native lignin precipitates are preferably hydrophobic. Hydrophobicity may be assessed using contact angle measurements.

The present native lignin precipitates may have any suitable number-average molecular Weight (Mₙ). For example, the Mₙ may vary from about 200 g/mol to about 2000 g/mol; about 300 g/mol to about 1500 g/mol; about 500 g/mol to about 1000 g/mol.

The present native lignin precipitates may have any suitable weight-average molecular Weight (M_{W}). For example, the M_{W} may vary from about 500 g/mol to about 4000 g/mol; about 750 g/mol to about 3000 g/mol; about 1000 g/mol to about 2000 g/mol.

One particular aspect of the invention provides the characteristic structural features related to the recovered native lignin derivatives from PVT's CCR-DASH process by using: ¹H, ¹³C, 2D HMQC/HSQC and HMBC NMR spectroscopic techniques to identify lignin structure/composition, inter-unit linkages (e.g., aryl ether, resinol, phenylcoumaran, etc), condensed and uncondensed aromatic and aliphatic carbons, and alkoxy groups etc. Compositional analysis of native lignin derivatives and other components of biomass derived from PVT's CCR-DASH process, following all related standard NREL Lab Analytical Procedures (LAPs) to establish baseline laboratory data and then modified to get meaningful quantitative data.

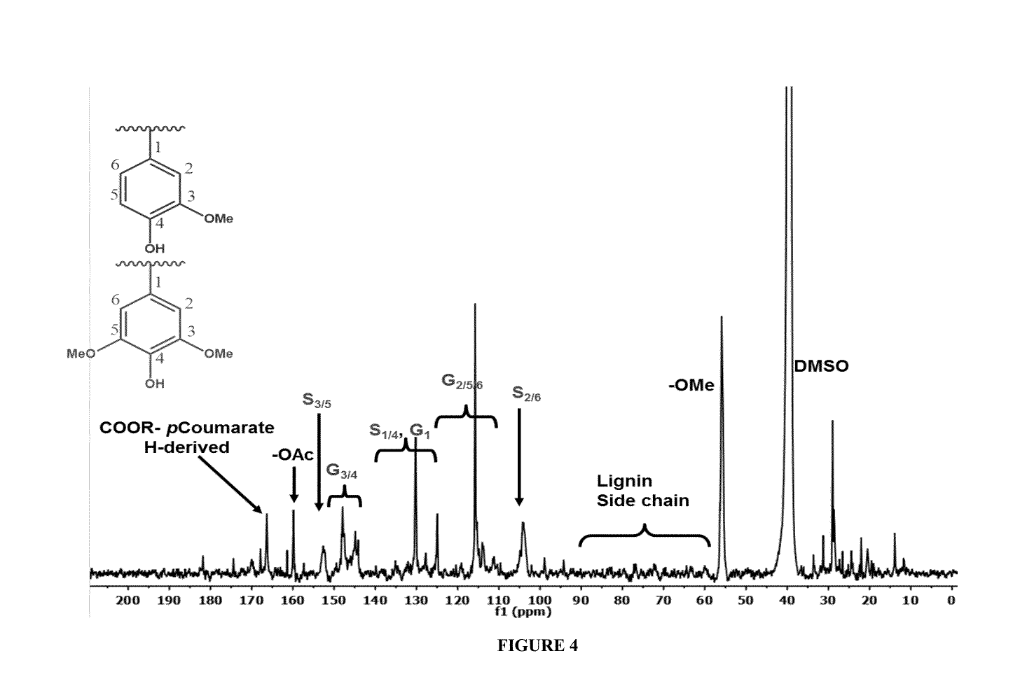

In the present invention, the lignin derivatives recovered from PVT's DSH-CCR process, were determined using ¹H, ¹³C and 2D HSQC NMR spectroscopic analysis. The recovered lignin derivatives (˜50 mg) from various lignocellulosic feedstocks (e.g., sugarcane bagasse, corn stover, etc.) were individually dissolved in DMSO-d₆ (0.75 ml) and subjected to NMR spectroscopic analysis [48, 49]. These experiments were performed on a Varian Inova 600 spectrometer equipped with a Nalorac dual broad band and HCN (2D) probe, respectively. ¹H NMR spectra of lignin isolates were carried out with a spectral width of 12,000 Hz and an acquisition time of 1.0 s, a delay between scans of 3.5 s and a 45 degree pulse-width. The Inverse-gated ¹³C NMR spectra were collected with a sweep width of 29,304 Hz, in 3 blocks of 10,000 scans and 1 block of 5,400 scans co-added for a total of 35,400 scans (FIGS. 4 B and 5B). Spectra were acquired using a 90° flip angle, 10 sec delay between scans and an acquisition time of 1.3 sec during which time the protons were decoupled. The NMR spectra were apodized using an exponential weighting function (lb=20 Hz) and zero filled to 128 k points prior to Fourier transformation followed by a baseline correction [49].

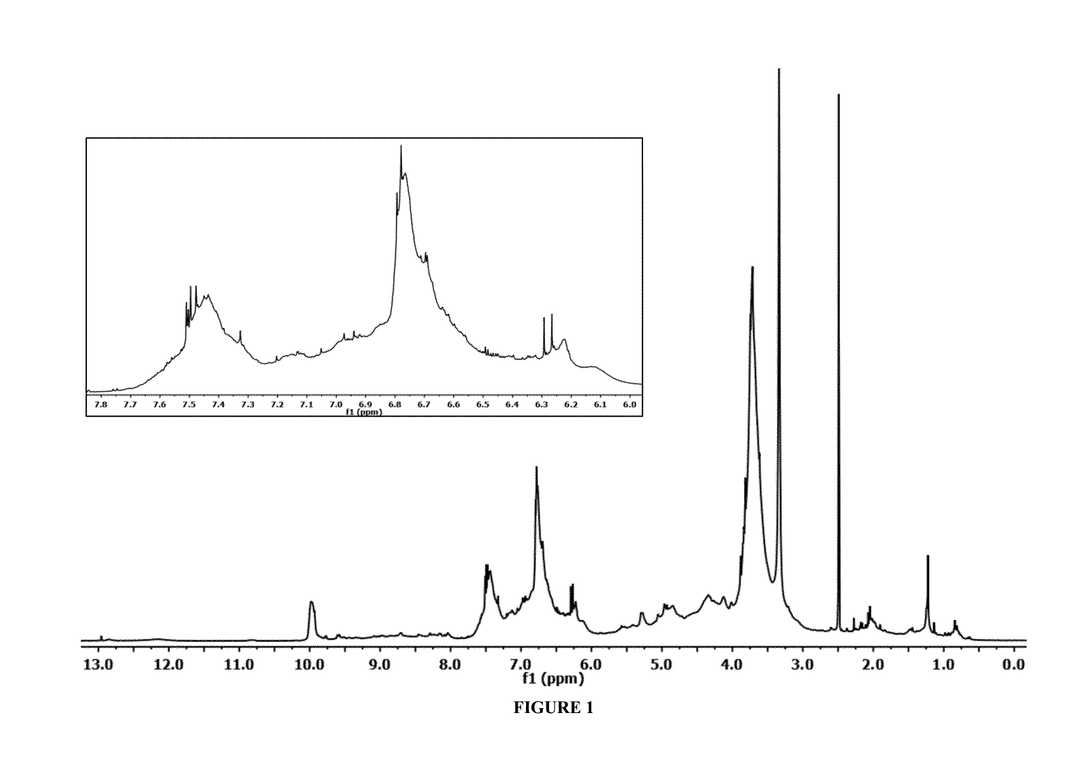

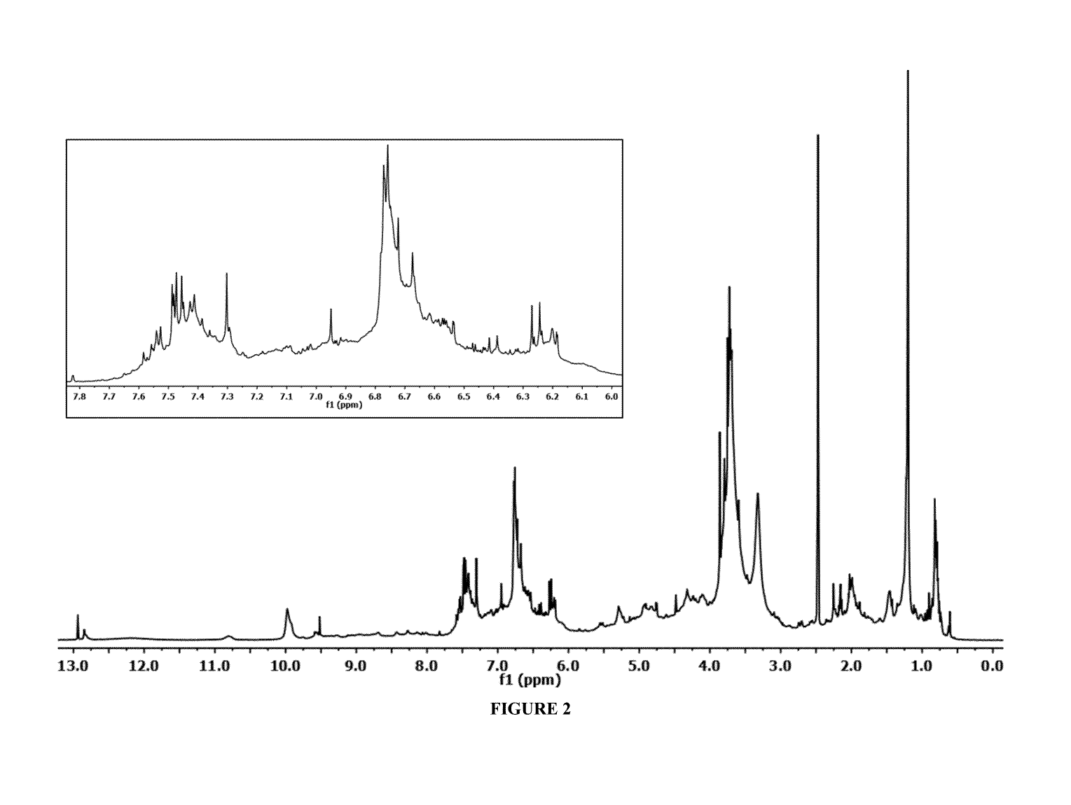

For example, the ¹H NMR solution spectra of lignin derivatives (FIGS. 1 and 2) recovered from CCR-DASH liquor revealed relevant chemical resonances values of both lignin oxygenated aliphatic side chain (δH ˜4.0 to 5.5 ppm) and substituted aromatic ring (δH ˜6.5 to 7.8 ppm), in addition to phenolic hydroxyls (δH ˜10.0 to 9.0 ppm) chemical shift values, thereby, providing evidence for the lignin derivative skeletal framework. Particularly, chemical shift values from δH ˜7.3 to 7.5 ppm in the ¹H NMR spectra (FIGS. 1 and 2), correspond to the 2, 6 aromatic ring proton of p-coumarates or p-coumaric acid (conjugated), indicating the H-units in the lignin derivative recovered from CCR-DASH are predominantly present in the p-coumaric acid form. The overall proton envelope in aromatic region within chemical shift values from δH ˜6.8 to 7.2 ppm correlated to the 2, 5 and 6 aromatic proton of etherified G-units, whereas; proton chemical shift values from δH ˜6.4 to 6.6 ppm corresponding to 2 and 6 aromatic ring proton of S lignin, indicating the presence of etherified S-units within the polymeric framework of the present lignin derivatives.

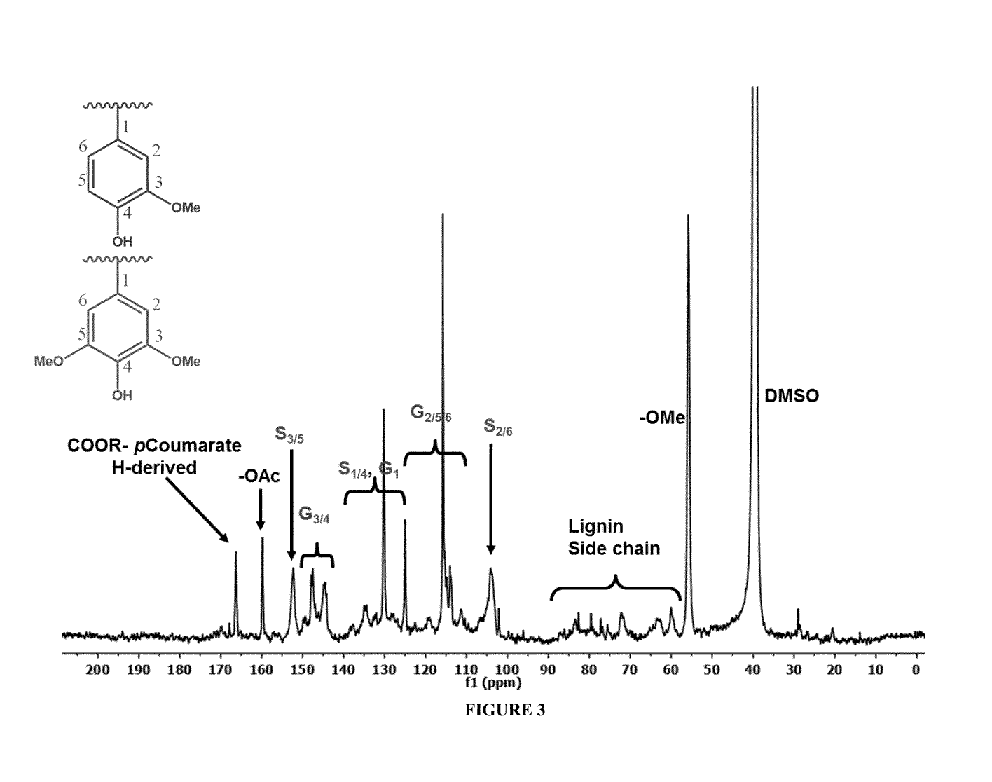

Particular aspects of the invention provide the characteristic structural features of the present lignin derivatives (e.g., from sugarcane bagasse and corn stover feedstocks), that were characterized using inverse gated ¹³C NMR analysis. The ¹³C-NMR spectrum of the lignin derivatives of the invention displayed the some, but not all, of the lignin resonances and chemical shift values of inter-unit linkages that resemble other lignin structure (FIGS. 3 and 4). The expected domain G/S aromatic ring resonances, together with characteristic methoxyl group (—OMe) signals at δc ˜55.8 ppm with readily discernible resonances for the G tertiary carbons-2, 5 and 6 (δc ˜107-124 ppm) and quaternary carbons-3 and 4 (δc ˜145-154 ppm) along with the S aromatic ring tertiary carbons-2 and 6 (δc ˜102-107 ppm) and quaternary carbons-3 and 5 (δc ˜150-154 ppm), were observed in the ¹³C NMR spectra of lignin derivatives of the invention (FIGS. 3 and 4). The existence of H-derived conjugated acid (p-coumarates) and H-derived non-conjugated acid (p-hydroxybenzoic acid) were relevant from the chemical shift values at δc ˜165-167 ppm and δc ˜168-169 ppm, respectively. The NMR estimated (semi-quantitative) purity of lignin derivatives of the invention (e.g., obtained from corn stover and sugarcane bagasse) revealed of about 90% or less purity with low molecular weight (LMW) nature was evident from the sharp resonance signal in ¹³C NMR spectra. Furthermore, relevant G and S unit chemical shift values in ¹³C NMR spectra of lignin derivatives of the present invention provided evidence for conservation of monolignol (monomeric) composition (G and S). Analysis of lignin oxygenated aliphatic region (δc ˜60 ppm to ˜90 ppm) of lignin derivatives of the invention (e.g., sugarcane bagasse and corn stover) strongly indicated the existence of lignin inter-unit linkages: 8-8′, 8-5′ and 5′-5″/β-O-4; 7-O-4′ while retaining the major 8-O-4′ inter-unit linkages.

Another aspect of the invention provides lignin derivatives that are significant difference in the lignin side chain region in comparison to other organosolvent lignin (for example, compared to those disclosed in U.S. Pat. No. 8,426,502, and U.S. patent application Ser. Nos. 12/705,939, 12/705,938 and 13/826,817). Particularly, the chemical shift values for the carbon resonances at δc ˜63 ppm and δc ˜70 ppm, corresponding to lignin inter-unit linkages: 8-5′ (phenylcoumaran) and 8-8′ (resinol), respectively, was found to be lowered as evidenced by relative decrease of resonance signal intensities in the ¹³C NMR spectra of lignin derivatives of the invention. By comparison to other organosolvent lignin, the lignin derivatives of the invention was found to contain higher degree of 8-O-4′ (aryl ether) inter-unit linkages with enhanced signal intensities at δc ˜60 ppm, δc ˜84 ppm, and δc ˜73 ppm, that is characteristic of C₉, C₈, and C₇ of 8-O-4′ sub-structure.

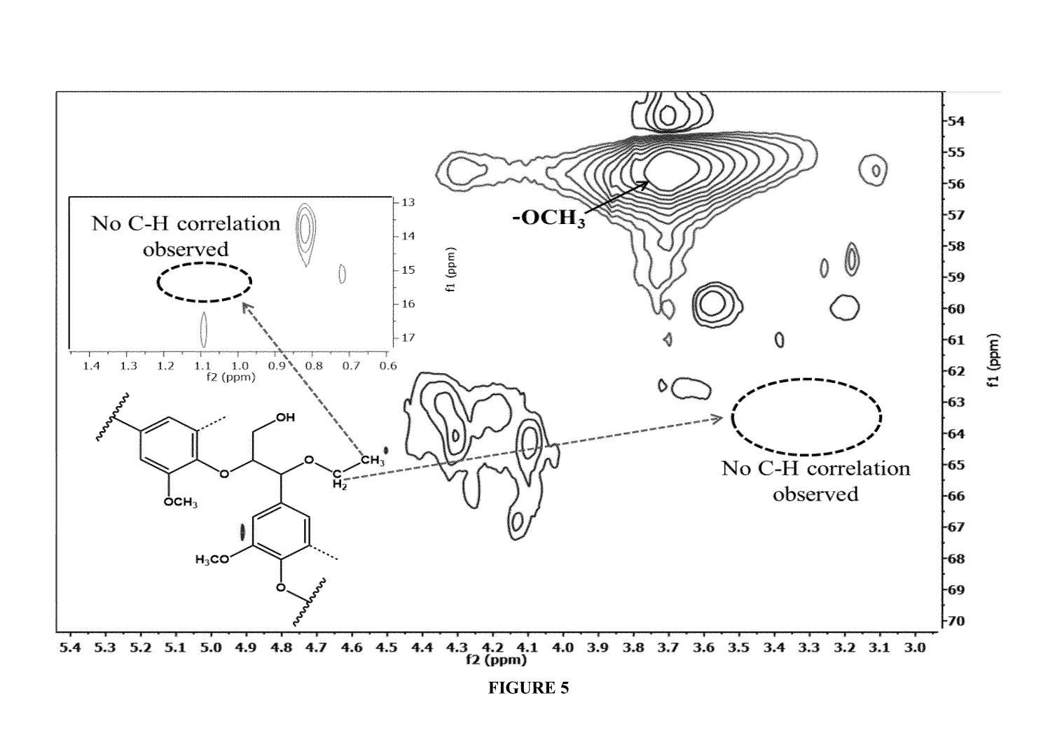

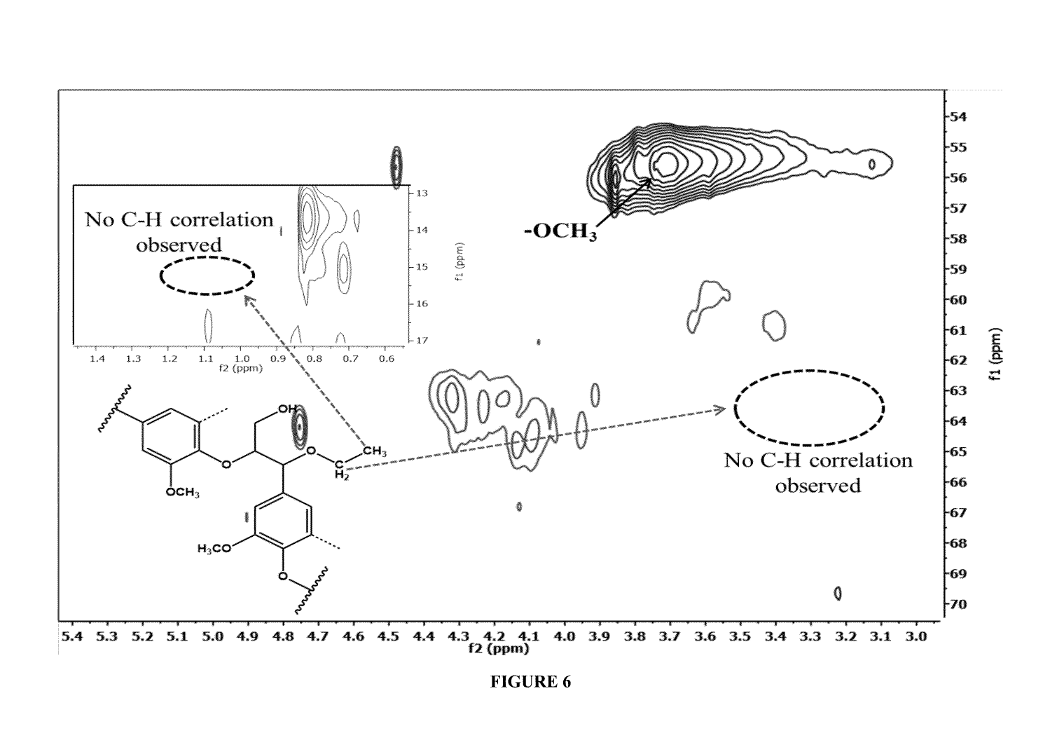

Other aspects of the invention provide evidence for non-existence of ethoxyl groups in the lignin derivatives of the present invention. Moreover, lignin derivative of the invention was found to have primarily lignin methoxy (i.e., —OCH₃) groups. The presence of methoxy groups in lignin derivatives of the invention was confirmed by inverse gated ¹³C NMR (at δc ˜55.8 ppm) and 2D HSQC NMR analysis (one bond C—H correlation at δc/δH ˜55.8/3.7 ppm). It should be noted that the presence of ethoxy groups in lignin derivatives from organosolvent process as described in U.S. Pat. No. 8,426,502, and U.S. patent application Ser. Nos. 12/705,939, 12/705,938 and 13/826,817, is considered to be characteristic for such organosolv derived lignins. The non-existence of one bond C—H correlation around δc/δH-15.5/1.1 ppm and δc/δH ˜63.5/3.3 ppm in the 2D HSQC NMR spectra of lignin derivatives of the invention (FIGS. 5 and 6) provide evidence for absence of any ethoxy groups. 2D HSQC NMR spectra were recorded by a Varian Inova 600 spectrometer equipped with a HCN (2D) probe. The acquisition parameters were as follows: An acquisition time of 0.199 s was used for the direct observe dimension and an acquisition time of 0.0066 s was used for the indirect dimension and 48 scans were taken per increment. A one-bond ¹H-¹³C J coupling of 150 Hz was used and a total of 2×160 increments in t1 were acquired using the gradient echo-antiecho selection technique for pure phase lineshape in F1. The FIDs were zero-filled once to 2048 points in t2, apodized with a Guassian function prior to Fourier Transformation. Data in t1 were extended by a factor of 2 with linear prediction followed by zero filling to 2K points, apodizing with a Guassian function and Fourier Transformation.

One particular aspect of the invention provides a modified lignin extraction method from CCR-DASH hydrolysates. The objective of the modified lignin extraction method is to extract granular native lignin derivatives and other by-products at high purity and yield from CCR-DASH hydrolysates. The modified method precipitates high purity lignin, >80% KL from CCR-DASH hydrolysates and may contain <1% sugar content. The overall process demonstrates a method to effectively precipitate two forms of lignin without altering the overall sugar yields in the final mother liquor. Native lignin derivatives with at least 75% KL content, at least 80% KL content, at least 85% KL content, at least 90% KL content, can be acquired from this extraction method. The said modified lignin extraction has been demonstrated in both a batch and continuous operations.

In certain aspects of the invention provides a continual 10 step lignin precipitation process that allow for extraction of a high purity (80% to 90% KL) lignin co-product from a CCR-DASH hydrolysate while maintaining the original sugar concentration in the final mother liquor. The pH and solvent (e.g., acetone) concentration plays an important role in the physical state (tarry or granular) at which lignin is precipitated. Inasmuch, the presence of already precipitated insoluble lignin (1^{st} lignin precipitate) has greater adverse effect on the physical state at which lignin can be further precipitated (2^{nd} lignin precipitate) (see Example 6). For an effective continual lignin precipitation to occur at pilot scale; solution pH (1.5 to 2.5), solvent (e.g., acetone) concentration, and insoluble lignin removal from solution must all be controlled to prevent a high dilution rate of DASH-CCR hydrolyzate to extract a high purity lignin co-product.

In some embodiments, solvents and/or reagents, such as acetone can be recovered and reused. Such recovery and reuse of solvents and/or reagents make the overall process of the invention economical and minimizes the environmental impact.

The present native lignin derivatives may be used for generation of various co-products and value-added products such as, for example; drop-in replacement fuels, aviation fuels, cyclohexane derivatives, aromatic hydrocarbons, ionic liquids, fine chemicals, phenols, phenolic derivatives, terephthalic acid, bio-plastics, lipids, fatty acids, antioxidants, sorbents, water repellents, flavoring agents, fertilizers, nanoporous carbons, carbon fibers, adhesives, paints, coatings, resins, and the like.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

### Example 1

### Recovery of Lignin Derivatives from Sugarcane Bagasse (SB-1)

The sugarcane bagasse used to make native lignin derivatives was harvested and extracted for sugars in Columbia in 2009. After drying and size reduction, via knife mill, to pass through a ½″ screen the sugarcane bagasse biomass was solubilized in PVT's countercurrent reactor (CCR) at 190° C. in 82:18:0.4 (by weight) acetone/water/sulfuric acid at a liquid flow rate of 723 g/minute and a dry biomass feed rate of 137 g/minute. SB-1 lignin isolates in the CCR liquid stream was purified by centrifugation to remove cellulosic fines, followed by heating the clarified liquid to 70° C. to reduce acetone and precipitate the lignin as an amorphous tar like material. The sugar rich liquid was decanted and the resulting tarry solids were re-solubilized in 80 mL of 7:1 acetone/water. This solution was then rotary evaporated to 50 mL, and the lignin was precipitated by slow addition of the concentrate into 1200 mL of water at neutral pH. The resulting free flowing lignin solids were separated from the liquid by vacuum filtration (Whatman 417) and washed with water before drying in vacuo at 30° C.

### Example 2

### Recovery of Lignin Derivatives from Corn Stover CS-1

The corn stover used to prepare the native lignin derivatives was harvested in Northern Colorado on Nov. 20, 2013. The corn stover biomass was air dried then sized reduced via knife mill to pass through a ½″ screen. The size reduced corn stover biomass was solubilized in PVT's CCR at 200° C. in 90:10:0.3 acetone/water/sulfuric acid (w:w:w) at a liquid flow rate of 1408 g/minute and a dry biomass feed rate of 142 g/minute. CS-1 lignin was prepared from the CCR liquid stream by first settling the fines and decanting the clear liquid. Acetone in the clarified liquid was reduced by heating to 62° C. at 1 bar and the lignin in this concentrate was precipitated by slow addition of the resulting concentrate (150 mL) into 750 mL of aqueous H₂SO₄ at pH 4.1. The resulting lignin was isolated by filtration (Whatman 417), washed with water and dried in vacuo at 30° C.

### Example 3

### Pilot Scale Recovery of Corn Stover Lignin Derivatives (CS-2) from Combined CCR Hydrolysate Fractions

Two liquid fractions from the CCR were combined to produce CS-2 lignin (Table 1). The first liquid fraction was produced where ground corn stover was solubilized with PVT's CCR in 90:10:0.3 acetone/water/sulfuric acid (w:w:w) at 200° C. with a liquid flow rate of 1400 g/minute and a dry biomass feed rate of 142 g/minute. The second fraction of solubilized corn stover was produced in the countercurrent reactor at 200° C. with 92:8:0.3 acetone/water/sulfuric acid (w:w:w) at a liquid flow rate of 1390 g/minute and a dry biomass feed rate of 125 g/minute. Cellulosic fines in the CCR liquid discharge were removed by sedimentation and decanting the clear liquid. The liquids were combined and concentrated with acetone reduction by heating to 60° C. and lignin in the concentrate was precipitated by slow addition of the concentrate to 5 volumes of water in a lignin precipitation system (LPS) (25 gal capacity). The precipitate was isolated by filtration and the solids were washed with water and dried in vacuo at 30° C.

### Example 4

### Pilot Scale Recovery of CS-3

Similar to the recovery of CS-2 lignin sample, another lignin isolate CS-3 (Table 1) was prepared from a combination of two CCR hydrolysate fractions. The first reaction in the CCR was performed at 180° C. with 83:17:0.5 acetone/water/sulfuric acid (w:w:w) at a liquid flow rate of 918 g/minute and a dry biomass feed rate of 137 g/minute. Correspondingly, the second reaction in the CCR used 180° C. with 82:18:0.5 acetone/water/sulfuric acid (w:w:w) at a liquid flow rate of 1418 g/minute and a dry biomass feed rate of 135 g/minute. The solubilized lignin was purified by settling the fines and decanting the clarified liquid. The liquid was then heated to 58° C. to reduce acetone and concentrate the lignin. To precipitate the lignin the concentrate was slowly added to 4 volumes of water acidified to pH 2.3 with sulfuric acid in the LPS of 25 gal capacity. The precipitate was isolated by filtration, washed with 10:90 acetone/water followed by a second water only wash then dried at 35° C. at 1 bar pressure.

TABLE 1
CCR conditions for sugarcane bagasse and corn
stover biomass samples for production of DASH
hydrolysate containing lignin derivatives.

| | | Run Solvent | | |
|---|---|---|---|---|
| | CCR | Composition | Liquid | Biomass |
| | Temperature | Acetone/Wa | Flow rate | Feed rate |
| Lignin | ° C. | ter/H₂SO₄ (w:w:w) | g/min | dry g/min |
| SB 1 | 190 | 82:18:0.2 | 723 | 137 |
| CS 1 | 200 | 90:10:0.3 | 1408 | 142 |
| CS 2 | 200 | 90:10:0.3 | 1392 | 142 |
| | 202 | 92:8:0.3 | 1388 | 125 |
| CS 3 | 180 | 83:17:0.5 | 918 | 137 |
| | 180 | 82:18:0.5 | 1418 | 135 |

TABLE 2
Compositional analysis of sugarcane bagasse and corn stover
lignin derivatives recovered from CCR-DASH hydrolysates

| | Non Volatile | | | Total Sugars |
|---|---|---|---|---|
| | Solids | Ash Content | KL Content | Content |
| Lignin | (w/w) | (w/w) | (w/w) | (w/w) |
| SB 1 | 97.1% | 1.4% | 93.7% | 4.4% |
| CS 1 | 92.8% | 1.1% | 92.8% | 5.0% |
| CS 2 | 95.0% | 0.9% | 82.7% | 9.1% |
| CS 3 | 95.7% | 0.5% | 88.5% | 5.2% |

### Example 5

### 1D and 2D NMR Spectroscopic Analysis of Lignin Derivatives Recovered from CCR-DASH Hydrolysate of Sugarcane Bagasse and Corn Stover Biomass

NMR spectra were recorded in DMSO-d6 at 300K on a Varian NMR System 600 MHz spectrometer (Agilent Technologies, Santa Clara, Calif., USA) equipped with a Nalorac dual broad band (1D) operating at 599.69 MHz for ¹H and 150.8 MHz for ¹³C. The residual solvent signal at 2.49 ppm for proton and 39.5 ppm for carbon was used for internal referencing of chemical shifts. Lignin samples were prepared as solutions of 50 to 60 mg/0.75 ml in DMSO-d6 (Cambridge Isotope Labs, Woburn Mass.). The ¹³C spectra were acquired with a sweep width of 29,304 Hz using an acquisition time of 0.4 s and a relaxation delay of 3.5 s. A 45 degree pulse was used and broadband ¹H decoupling was used only during the acquisition time. A total of 35,400 scans (3 blocks of 10,000 scans and 1 block of 5,400 scans co-added) were recorded for each spectrum. Spectra were acquired using a 90° flip angle, 10 sec delay between scans and an acquisition time of 1.3 sec during which time the protons were decoupled. The ¹H NMR spectra was recorded at same concentration of lignin with using a sweep width of 9,600 Hz. An acquisition time of 1.0 s, a relaxation delay of 3.5 s and a 45 degree pulse were used to collect 128 scans for each spectrum. The 1D spectra were apodized using an exponential weighting function (lb=20 Hz) and zero filled to 128 k points prior to Fourier transformation followed by a baseline correction.

The isolated lignin derivatives (˜50 mg) from recovered from CCR-DASH hydrolysate of sugarcane bagasse and corn stover biomass were individually dissolved in DMSO-d6 (0.75 ml) and subjected to 2D NMR spectroscopic analysis [48, 49]. These experiments were performed on a Varian Inova 600 spectrometer equipped with a HCN (2D) probe. 2D HSQC NMR spectra were acquired using pulsed field gradient coherence selection and using spectral editing to allow for discrimination of methyl and methine signals from those of methylene signals. Spectral widths of 6,250 and 24,125 Hz were used for the 1H and 13C dimensions respectively. An acquisition time of 0.199 s was used for the direct observe dimension and an acquisition time of 0.0066 s was used for the indirect dimension and 48 scans were taken per increment. A one-bond 1H-13C J coupling of 150 Hz was used and a total of 2×160 increments in t1 were acquired using the gradient echo-antiecho selection technique for pure phase lineshape in F1. The FIDs were zero-filled once to 2048 points in t2, apodized with a Guassian function prior to Fourier Transformation. Data in t1 were extended by a factor of 2 with linear prediction followed by zero filling to 2K points, apodizing with a Guassian function and Fourier Transformation.

### Example 6

### Modified Method for Extraction of Native Lignin Derivatives from CCR-DASH Hydrolysate

Native lignin derivatives were precipitated via semi-dropwise addition of CCR-DASH hydrolysate (feedstock) to a H₂SO₄/H₂O solution. The pH of H₂SO₄/H₂O solution was kept at 2.3±0.2. The pH was controlled in the feedstock via 10M/1M NaOH addition. One liter of 0.05%±0.02 H₂SO₄/H₂O solution was heated to 50° C. with constant stirring via 2″ PTFE coated magnetic stir bar. Once the solution reached 50° C., 100 mL of feedstock was added semi-dropwise to the H₂SO₄/H₂O solution. Prior to feedstock addition, the stirring rate was increased to create an apparent vortex. After the feedstock addition, the resulting slurry was allowed to further mix at 50° C. for 15±5 minutes.

There were 10×100 mL sequential additions of feedstock (CCR-DASH hydrolysate) to the H₂SO₄/H₂O solution. For odd number additions of feedstock, the slurry was filtered using a VWR 417 glass fiber filter (40 um) to recover solid residues, which was considered the 1^{st} lignin precipitate. Then solvent (e.g., acetone) was removed by rotary evaporating, to circa 35-40 mbar with a rotation at 100 rpm, to bring the resulting filtrate to the original solution weight prior to feedstock addition at 50° C. Then the filtrate was filtered again using a VWR 413 glass fiber filter (5 um), with the corresponding filtered residues being considered as the 2^{nd} lignin precipitate. It should be noted that the second precipitate was always filtered following acetone removal, since the precipitated material was <40 um in diameter but >5 um, as observed from filtration pass test (5 um). Furthermore, the 2^{nd} precipitate only precipitated after acetone removal. This filtrate was then used as the starting material for even number additions. On even number 100 mL feedstock additions, after letting the slurry mix for 15 minutes at 50° C., following the feedstock addition, acetone was subsequently removed via rotary evaporation (40 mbar, 100 rpm) at 50° C. without intermediate filtration step (as carried out for odd number addition), while regaining the original solution weight prior to corresponding feedstock addition. The resulting evaporated slurry mix was filtered using VWR 417 and VWR 413 glass fiber filters to recover the corresponding 1^{st} and 2^{nd} lignin precipitates, respectively for even number feedstock additions. Consequently, the resulting filtrate was used as the starting material for the subsequent odd number additions. The purpose of alternating feedstock addition and filtering the 1^{st} lignin precipitate in the presence and absence of acetone was to determine whether the 2^{nd} precipitate was contaminating the 1^{st} lignin precipitate under the tested addition/precipitation conditions.

TABLE 3
Gravimetric data and KL analysis of lignin precipitates during
10 step lignin precipitation process of CCR-DASH hydrolysate

| | Sample | Lignin 1 st | Lignin 2nd | ¹ Total | ²Normalized | ³Normalized | |
|---|---|---|---|---|---|---|---|
| Feedstock | addition wt. | precipitate | precipitate | lignin wt | 1st lignin ppt | total lignin | KL content |
| addition # | (in g) | (in g) | (in g) | (in g) | (in %) | (in %) | (in %) |
| 1 | 89.7 | 2.0823 | 0.2511 | 2.3334 | 2.32% | 2.60% | 86.80% |
| 2 | 106.4 | 2.4132 | 0.0561 | 2.4693 | 2.27% | 2.32% | 85.66% |
| 3 | 97.0 | 2.3554 | 0.5522 | 2.9076 | 2.43% | 3.00% | 85.80% |
| 4 | 92.9 | 2.7027 | 0.0278 | 2.7305 | 2.91% | 2.94% | 83.29% |
| 5 | 101.1 | 2.309 | 0.5632 | 2.8722 | 2.28% | 2.84% | 79.25% |
| 6 | 98.0 | 3.1271 | 0.1816 | 3.3087 | 3.19% | 3.38% | 83.32% |
| 7 | 98.9 | 2.9095 | 0.5154 | 3.4249 | 2.94% | 3.46% | 83.52% |
| 8 | 100.2 | 3.6497 | 0.3523 | 4.002 | 3.64% | 3.99% | 81.68% |
| 9 | 93.1 | 2.2564 | 0.5165 | 2.7729 | 2.42% | 2.98% | * |
| 10 | 92.1 | 3.1676 | 0.2997 | 3.4673 | 3.44% | 3.76% | 81.78% |

¹ Total lignin weight is the summation of Lignin 1^{st} ppt wt and Lignin 2^{nd} ppt wt.
²Normalized 1^{st} Lignin ppt- is Lignin 1^{st} ppt wt/sample addition wt.
³Normalized total lignin- is Total lignin wt./sample addition wt.
* KL analysis wasn't performed

TABLE 4
Sugar balance data of original feedstock and final filtrate after 10 step lignin precipitation process

| | | | | | | | | Total | Total |
|---|---|---|---|---|---|---|---|---|---|
| | Glucose | Xylose | Galactose | Arabinose | Mannose | HMF | Furfural | Sugar | Furan |
| Sample | (g/kg) | (g/kg) | (g/kg) | (g/kg) | (g/kg) | (g/kg) | (g/kg) | (g/kg) | (g/kg) |
| Original | 11.26 | 17.20 | NA | 3.49 | NA | 1.03 | 3.73 | 28.31 | 4.76 |
| Feedstock | | | | | | | | | |
| Final Filtrate | 10.59 | 14.26 | NA | 2.94 | NA | 0.826 | 2.06 | 27.79 | 2.89 |
| Recovered | | | | | | | | | |

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

### REFERENCES

[1] Ragauskas A J, Williams C K, Davison B H, Britovsek G, Cairney J, Eckert C A, et al. The path forward for biofuels and biomaterials. Science, 2006 Jan. 27; 311(5760):484-9.
[2] Boerjan W, Ralph J, Baucher M. Lignin biosynthesis. Annual Review of Plant Biology, 2003; 54: 519-46.
[3] Ralph J, Grabber J H, Hatfield R D. Lignin-ferulate cross-links in grasses: active incorporation of ferulate polysaccharide esters into ryegrass lignins. Carbohydrate Research, 1995; 275(1):167-78.
[4] Ralph J. An unusual lignin from kenaf. Journal of natural products, 1996; 59(4):341-2.
[5] Ralph J, Hatfield R D, Grabber J H, Jung H G, Quideau S, Helm R F. Cell wall cross-linking by ferulates and diferulates in grasses. Lewis N G: American Chemical Society, Washington, D.C.; 1998.
[6] Ralph J, Hatfield R D, Piquemal J, Yahiaoui N, Pean M, Lapierre C, et al. NMR characterization of altered lignins extracted from tobacco plants down-regulated for lignification enzymes cinnamylalcohol dehydrogenase and cinnamoyl-CoA reductase. Proceedings of the National Academy of Sciences, 1998; 95(22):12803-8.
[7] Lewis N G, Davin L B. The biochemical control of monolignol coupling and structure during lignan and lignin biosynthesis. Lewis N G, editor: Amer. Chem. Soc., Washington, D.C.; 1998.
[9] Sederoff R R, MacKay J J, Ralph J, Hatfield R D. Unexpected variation in lignin. Current opinion in plant biology, 1999; 2(2):145-52.
[10] Davin L B, Lewis N G. An historical perspective on lignan biosynthesis: monolignol, allylphenol and hydroxycinnamic acid coupling and downstream metabolism. Phytochemistry Reviews, 2003; 2(3):257-88.
[11] Ralph J, Lundquist K, Brunow G, Lu F, Kim H, Schatz P F, et al. Lignins: Natural polymers from oxidative coupling of 4-hydroxyphenylpropanoids. Phytochemistry Reviews, 2004; 3(1-2):29-60.
[12] Davin L B, Lewis N G. Dirigent phenoxy radical coupling: advances and challenges. Current opinion in biotechnology, 2005; 16(4):398-406.
[13] Laskar D D, Corea O R, Patten A M, Kang C H, Davin L B, Lewis N G. Vascular Plant Lignification: Biochemical/Structural Biology Considerations of Upstream Aromatic Amino Acid and Monolignol Pathways. Wong C-HaW, P. G., editor: Oxford: Elsevier; 2010.
[14] Björkman A. Studies on finely divided wood. Part 1. Extraction of lignin with neutral solvents. Svensk Papperstidning, 1956; 59(13):477-85.
[15] Sarkanen K V, Ludwig C H. Lignins: occurrence, formation, structure and reactions. New York: Wiley-Interscience; 1971.
[16] Chang H, Cowling E B, Brown W. Comparative studies on cellulolytic enzyme lignin and milled wood lignin of sweetgum and spruce. Holzforschung-International Journal of the Biology, Chemistry, Physics and Technology of Wood; 1975; 29(5):153-9.
[17] Gellerstedt G, Northey R A. Analysis of birch wood lignin by oxidative degradation. Wood science and technology, 1989; 23(1):75-83.
[18] Browning B L. Methods of wood chemistry, Volumes I & II. 1967. [19] Fasching M, Schröder P, Wollboldt R P, Weber H K, Sixta H. A new and facile method for isolation of lignin from wood based on complete wood dissolution. Holzforschung, 2008; 62(1):15-23.
[20] Zhang X, Yuan T, Peng F, Xu F, Sun R. Separation and Structural Characterization of Lignin from Hybrid Poplar Based on Complete Dissolution in DMSO/LiCl. Separation Science and Technology, 2010; 45(16):2497-506.
[21] Sjöström E. Wood Chemistry, 2nd ed.: New York: Academic Press; 1999.
[22] Gierer J. The reactions of lignin during pulping. A description and comparison of conventional pulping processes: DTIC Document 1970.
[23] Smook G A. Handbook for Pulp & Paper Technologists: Vancouver: Angus Wilde Publications; 1992.
[24] Uloth V C, Wearing J T. Kraft lignin recovery acid percipitation versus ultrafiltration. Part I. Laboratory test results. Pulp and Paper Canada, 1989; 90(9):67-71.
[25] Uloth V C, Wearing J T. Kraft lignin recovery: acid precipitation versus ultrafiltration. Part II. Technology and economics. Pulp and Paper Canada, 1989; 90(10):34-7.
[26] Fields P R, Ragg P L, inventors; Production of lignin, 1990.
[27] Tanistra I, Bodzek M. Preparation of high-purity sulphate lignin from spent black liquor using ultrafiltration and diafiltration processes. Desalination, 1998; 115 (2): 111-20.
[28] Patel P V, Rane V C. The kraft lignin recovery from black liquor. Chemical Industry Digest, 1999; 12(2):114-8.
[29] Gomez D, Luque S, Alvarez J R, Coca J. Lignin recovery in a kraft paper pulp manufacturing plant by membrane techniques. Investigacion y Tecnica del Papel, 2000; 37(143):66-85.
[30] Jönsson A S, Wallberg O. Cost estimates of kraft lignin recovery by ultrafiltration. Desalination, 2009; 237(1):254-67.
[31] Xu K M, Liu H Y, Dong L, Tong S, Liu Y J. Lignin Recovery from the Black Liquor of Reed Pulping. Advanced Materials Research, 2012; 512:2376-80.
[32] Antonsson S, Henriksson G, Johansson M, Lindstroem M E. Low Mw-lignin fractions together with vegetable oils as available oligomers for novel paper-coating applications as hydrophobic barrier. Industrial Crops and Products, 2008; 27(1):98-103.
[33] Fernando S, Adhikari S, Chandrapal C, Murali N. Biorefineries: current status, challenges, and future direction. Energy & Fuels, 2006; 20(4):1727-37.
[34] Yang B, Wyman C E. Pretreatment: the key to unlocking low-cost cellulosic ethanol. Biofuels, Bioproducts and Biorefining, 2007; 2(1):26-40.
[35] Amidon T E, Wood C D, Shupe A M, Wang Y, Graves M, Liu S. Biorefinery: conversion of woody biomass to chemicals, energy and materials. Journal of Biobased Materials and Bioenergy, 2008; 2(2):100-20.
[36] Liu S, Amidon T E, Francis R C, Ramarao B V, Lai Y Z, Scott G M. From forest biomass to chemicals and energy. Biorefinery initiative in New York State. Industrial Biotechnology, 2006; 2(2):113-20.
[37] Stipanovic A J, Haghpanah J S, Amidon T E, Scott G M, Barber V, Mishra K. Opportunities for hardwood hemicellulose in biodegradable polymer blends. Materials, Chemicals, and Energy from Forest Biomass, cap., 2007; 7:107.
[38] Bujanovic B M, Goundalkar M J, Amidon T E. Increasing the value of a biorefinery based on hot-water extraction: lignin products. Tappi Journal, 2012; 11(1):19-26.
[39] Yang H, Yan R, Chen H, Lee D H, Zheng C. Characteristics of hemicellulose, cellulose and lignin pyrolysis. Fuel, 2007; 86(12-13):1781-8.
[40] Varhegyi G, Antal M J, Jakab E, Szab A P. Kinetic modeling of biomass pyrolysis. Journal of Analytical and Applied Pyrolysis, 1997; 42(1):73-87.
[41] Abächerli, A., and Doppenberg, F. (2001). Method for preparing alkaline solutions containing aromatic polymers.
[42] Agar, R. C., Cronlund, M., Goyal, G. C., Katzen, R., LeBlanc, R., Lora, J. H., Raskin, M. N., Winner, S. R., and Wu, C. F. (1998). Method of recovering furfural from organic pulping liquor.
[43] Axegard, P., Oehman, F., Theliander, H., and Tomani, P. (2006). Method for separating lignin from black liquor.
[44] Oehman, F., Theliander, H., Norgren, M., Tomani, P., and Axegaard, P. (2006). Method for separating lignin from a lignin containing liquid/slurry.
[45] Feldman, D. (2002). Lignin and its polyblends—a review, Chemical Modification, Properties, and Usage of Lignin (New York: Springer).
[46] Sahoo, S., Seydibeyo\check{g}lu, M. Ö., Mohanty, A. K., and Misra, M. (2011). Characterization of industrial lignins for their utilization in future value added applications. Biomass and Bioenergy 35, 4230-4237.
[47] Stewart, D. Lignin as a base material for materials applications: Chemistry, application and economics. Industrial Crops and Products, 2008, 27, 202-207.
[48] Laskar D D, Jourdes M, Patten A M, Helms G L, Davin L B, Lewis N G. The Arabidopsis cinnamoyl CoA reductase irx4 mutant has a delayed but coherent (normal) program of lignifications. Plant Journal, 2006, 48(5):674-686.
[49] Jourdes M, Cardenas C L, Laskar D D, Moinuddin S G A, Davin L B, Lewis N G. Plant cell walls are enfeebled when attempting to preserve native lignin configuration with poly-p-hydroxycinnamaldehydes: Evolutionary implications. Phytochemistry, 2007, 68, 1932-1956.

What is claimed is:

1. A lignin derivative recovered from a biorefinery process of a lignocellulosic biomass, wherein said lignin derivative has no ethoxy substituent in the 2D HSQC NMR spectra, and ash content of about 1.5% or less.

2. The lignin derivative of claim 1, wherein said lignin derivative comprises sugar content of about 10% or less.

3. The lignin derivative of claim 1, wherein said lignin derivative comprises Klason Lignin (KL) content of about 95% or less.

4. The lignin derivative of claim 1, wherein said lignin derivative comprises p-coumaric acid.

5. The lignin derivative of claim 1, wherein said lignin derivative comprises etherified G-units.

6. The lignin derivative of claim 1, wherein said lignin derivative comprises etherified S-units.

7. The lignin derivative of claim 1, wherein said lignin derivative comprises methoxy groups.

8. The lignin derivative of claim 1, wherein said lignin derivative comprises lower 8-5′ (phenylcoumaran) and 8-8′ (resinol) lignin inter-unit linkages.

9. The lignin derivative of claim 1, wherein said lignin derivative comprises higher degree of 8-O-4′ (aryl ether) inter-unit linkages.

10. The lignin derivative of claim 1, wherein the number-average molecular Weight (Mₙ) ranges from about 200 g/mol to about 2000 g/mol.

11. The lignin derivative of claim 1, wherein the weight-average molecular Weight (M_{W}) ranges from about 500 g/mol to about 4000 g/mol.

12. A lignin derivative having ¹H NMR peaks at: δH ˜4.0 ppm to 5.5 ppm, δH ˜6.4 ppm to 6.6 ppm, δH ˜6.8 ppm to 7.2 ppm, δH ˜7.3 ppm to 7.5 ppm, and δH ˜9.0 ppm to 10.0 ppm.

13. The lignin derivative of claim 12, wherein said lignin derivative further has ¹³C NMR peaks at: δc ˜60 ppm to 90 ppm, δc ˜102 ppm to 107 ppm, δc ˜107 ppm to 124 ppm, δc 145 ppm to 154 ppm, δc ˜150 ppm to 154 ppm, and δc ˜165 ppm to 169 ppm.

14. A lignin derivative comprising inverse gated ¹³C NMR peak at δc ˜55.8 ppm.

15. The lignin derivative of claim 14 further comprising 2D HSQC NMR peak at δc/δH ˜55.8/3.7 ppm.

16. The lignin derivative of claim 14, wherein said lignin derivative has no peaks at δc/δH ˜15.5/1.1 ppm in the 2D HSQC NMR spectra.

17. The lignin derivative of claim 14, wherein said lignin derivative has no peaks at δc/δH ˜63.5/3.3 ppm in the 2D HSQC NMR spectra.
